(19) United States
(12) Patent Application Publication
(10) Pub. No.: US 2013/0162440 A1
(43) Pub. Date: Jun. 27, 2013

(54) Downhole Pressure Pulse Generator And Method

(71) Applicant: SCHLUMBERGER TECHNOLOGY CORPORATIO, Sugar Land, TX (US)

(72) Inventors: Andrew J. Parry, Bourg La Reine (FR); Sylvain Thierry, Le Mesnil St Denis (FR); Emma Barsellotti, Cedex (FR)

(73) Assignee: SCHLUMBERGER TECHNOLOGY CORPORATION, Sugar Land, TX (US)

(21) Appl. No.: 13/684,573

(22) Filed: Nov. 25, 2012

(30) Foreign Application Priority Data
Dec. 22, 2011 (EP) 11290602.9

(51) Int. Cl. G01V 3/18

(52) U.S. Cl. CPC G01V 3/18
USPC 340/854.3

(57) ABSTRACT

A downhole pressure pulse generator (138) and methods for generating pressure pulses therewith are disclosed. The pressure pulse generator can include an input port (1) and an output port (4) for passing a drilling fluid therethrough. The pressure pulse generator can include a constricting conduit (2) that provides fluid communication between the input port and the output port. The pressure pulse generator can include a control port (3) that inputs a control fluid into the constricting conduit. The pressure pulse generator can include a control device that generates at least one pulse in the drilling fluid by selectively altering flow of the control fluid.

### BACKGROUND

A well or borehole can be drilled into the ground to recover natural deposits of hydrocarbons and/or other desirable materials trapped in a geological formation in the Earth's crust. A well or borehole may be drilled using a drill bit attached to a lower end of a drill string. The well or borehole may be drilled to penetrate subsurface geological formation in the Earth's crust, which contain the trapped hydrocarbons and/or other materials. As a result, the trapped hydrocarbons and/or materials may be recovered via the well or borehole.

A bottom hole assembly (hereinafter “BHA”) is located at the lower end of the drill string and may include the drill bit along with one or more sensors, control mechanisms and/or circuitry. The one or more sensors of the BHA may detect one or more downhole measurements associated with one or more properties of the subsurface geological formation, fluid and/or gas, which may be contained within the formation. Additionally, the one or more sensors of the BHA may detect or measure one or more downhole measurements associated with an orientation or a position of the BHA and the drill bit with respect to the subsurface geological formation, the natural deposits of hydrocarbons, and the surface of the Earth.

Drilling operations for the drill bit located at the BHA of the drill string may be controlled by an operator (or group of operators) located at the Earth's surface or at an operations support center located locally or remotely with respect to the wellsite. The drill string may be rotated at a rotational rate by a rotary table, or a top drive located at the Earth's surface. The operator may control the rotational rate, an amount of weight-on-bit and/or other operating parameters associated with the drilling process.

Drilling mud may be pumped from the Earth's surface to the drill bit via an interior passage of the drill string. The drilling mud may cool and/or lubricate the drill bit during the drilling process by being pumped downhole via the drill string. Additionally, the drilling mud may transport drill cuttings, which may be cut from the geological formations by the drill bit, uphole back to the Earth's surface. The drilling mud may have a density, which may be controlled by the operator to maintain hydrostatic pressure in the borehole at desired levels.

To facilitate drilling operations for the well or borehole, the downhole measurements made by the one or more sensors of the BHA can be used. In order for the operator to access the downhole measurements for controlling and steering the drill bit, a communication link may be established between the operator at the Earth's surface and the BHA of the drill string. A “downlink” refers to a communication link extending downhole from the Earth's surface to the BHA of the drill string. Based on one or more downhole measurements collected by the one or more sensors located at the BHA, the operator may send or transmit one or more commands downhole to the BHA via a downlink. The commands may include one or more instructions for the BHA, which may facilitate a change in operational parameters of any of the one or more sensors, or a steering of a direction of the drilling by the drill bit.

An “uplink” refers to a communication link uphole from the BHA of the drill string to the Earth's surface. An uplink may include a transmission of the data associated with the one or more downhole measurements, which may be detected by the one or more sensors located at the BHA. For example, an operator may make use of measurements relating to the orientation of the BHA with respect to the geological formation. Thus, orientation data or measurements detected by one or more sensors located at the BHA may be transmitted uphole from the BHA to the Earth's surface via the uplink. Additionally, an uplink communication may also be used to confirm that the commands previously transmitted via the downlink were received.

Mud pulse telemetry is a well-established technique for providing a communication link in either direction between the Earth's surface and the BHA. Mud pulse telemetry is a method of sending or transmitting one or more signals, either downlink or uplink communications, by creating one or more pressure and/or flow rate pulses (hereinafter “pressure pulses”) in the drilling mud. The pressure pulses may be detected by one or more sensors at a receiving location, which may be located at, near or adjacent to the Earth's surface, as well as downhole repeaters. For example, in a downlink communication, a change in the pressure or flow rate of drilling mud being pumped down the interior passage of the drill string may be detected by at least one sensors of the BHA. A pattern imposed on the pulses, such as a frequency, a phase, and/or an amplitude, may be representative of the command sent or transmitted by the operator located at Earth's surface. The pattern of the pressure pulses may be detected by at least one sensor of the BHA and may be interpreted such that the command may be understood by the BHA, the sensors, or the drill bit of the drill string. Conversely, sensors near the surface may detect the pattern of pressure pulses in an uplink and one or more surface processors may interpret the data encoded therein.

Mud pulse telemetry systems have been developed, including a “poppet” pulse generating valve, a rotary valve or a “siren” pulse generating valve, and oscillating pulse generating valve. Some pulse generating valves are subject to jamming and erosion, given the nature of moving parts, and some have power consumption levels that are limiting in a downhole environment.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In an embodiment, a pressure pulse generator is disclosed for generating pulses in a flowing fluid to communicate between a bottom hole assembly in a wellbore and surface equipment. The pressure pulse generator can include an input port having an input dimension into which a fluid flow enters. The pressure pulse generator can include an output port having an output dimension out of which the fluid flow exits. The pressure pulse generator can include a constricting conduit that provides fluid communication between the input port and the output port. The pressure pulse generator can include a control port that inputs a control flow into the constricting conduit. The pressure pulse generator can include a control device that generates at least one pulse in the fluid flow by selectively altering the control flow.

In an embodiment, a wellbore communication system is disclosed for generating pulses in a flowing fluid to communicate between a bottom hole assembly in a wellbore and surface equipment. The system can include a pulse generator as described above. The system can also include a pressure pulse transducer that detects the pressure pulses generated by the pulse generator. The system can also include a processor that decodes the pressure pulses detected by the pressure pulse transducer.

In an embodiment, a method is disclosed for while-drilling communication based on pressure pulses in a flowing fluid between a bottom hole assembly in a wellbore and surface equipment. The method can include disposing in a drilling fluid flow line a pulse generator as described above, and passing a fluid flow through the input port of the pulse generator to the output port of the pulse generator. The method can include generating at least one pulse in the fluid flow by selectively passing the control fluid flow through the control port to the constricting conduit of the pulse generator.

### BRIEF DESCRIPTION OF THE DRAWINGS

Embodiments of this disclosure are described with reference to the following figures. The same numbers are used throughout the figures to reference like features and components. A better understanding of the methods or apparatuses can be had when the following detailed description of the several embodiments is considered in conjunction with the following drawings, in which:

FIG. 1 illustrates a schematic diagram, including a partially cross-sectional view, of a drilling system having a pulse generator in accordance with various embodiments of the present disclosure connected to a drill string and deployed from a rig into a wellbore.

FIGS. 2-1 and 2-2 illustrate cross-sectional views of a pulse generator in accordance with various embodiments of the present disclosure.

FIG. 3 shows examples of changes in velocity and pressure fields through a device such as illustrated in FIGS. 2-1 and 2-2.

FIG. 4 is a graph showing an example of a resulting pressure signature produced by a device in accordance with an embodiment of the present disclosure.

FIGS. 5-1 and 5-2 are schematic diagrams depicting an example embodiment of the device of FIGS. 2-1 and 2-2.

FIG. 6 is a plot of amplification in pressure as a function of control flow rate ratio from a simulated example.

FIG. 7 is a flowchart for a method in accordance with one embodiment of the present disclosure.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

The present application discloses a Venturi-type fluidic amplifier as a pressure pulse modulator, and methods for generating pressure pulses with the same. A main flow passes through a narrowed throat in the fluidic amplifier. Upon passing through the narrowed throat, a pressure drop can be generated in the flow between the inlet and outlet of the amplifier. The pressure drop can be modulated by selectively applying a control flow at a control port in the throat. In one embodiment, the control flow rate is on the order of approximately one-tenth of the main flow rate, though any percentage of the main flow rate may be selected as the control flow rate. The control flow can be applied selectively, in either a binary fashion (i.e., either off or on) or continuously varying either amount of rate of change in control flow, and thus both amplitude and frequency modulation can be achieved. The control flow (as a percentage of the total flow) may be selectively controlled to reduce power consumption. Additionally, the main flow pathway may be free of moving parts to reduce potential erosion and jamming.

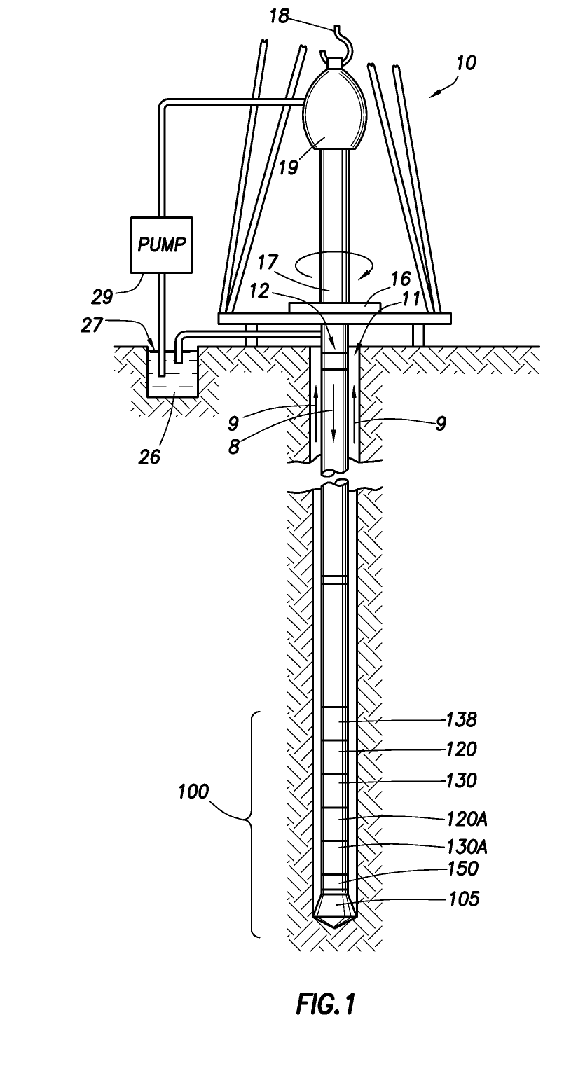

With the foregoing in mind, FIG. 1 illustrates a wellsite system in which the disclosed pressure pulse generator can be employed. The wellsite system of FIG. 1 may be onshore or offshore. In the wellsite system of FIG. 1, a borehole 11 may be formed in subsurface formations by rotary drilling using any suitable technique. A drill string 12 may be suspended within the borehole 11 and may have a bottom hole assembly 100 that includes a drill bit 105 at its lower end. A surface system of the wellsite system of FIG. 1 may include a platform and derrick assembly 10 positioned over the borehole 11, the platform and derrick assembly 10 including a rotary table 16, kelly 17, hook 18 and rotary swivel 19. The drill string 12 may be rotated by the rotary table 16, energized by any suitable means, which engages the kelly 17 at the upper end of the drill string 12. The drill string 12 may be suspended from the hook 18, attached to a traveling block (not shown), through the kelly 17 and the rotary swivel 19, which permits rotation of the drill string 12 relative to the hook 18. A top drive system could alternatively be used, which may be a top drive system well known to those of ordinary skill in the art.

In the wellsite system of FIG. 1, the surface system may also include drilling fluid or mud 26 stored in a pit 27 formed at the well site. A pump 29 may deliver the drilling fluid 26 to the interior of the drill string 12 via a port in the swivel 19, causing the drilling fluid to flow downwardly through the drill string 12 as indicated by the directional arrow 8. The drilling fluid 26 may exit the drill string 12 via ports in the drill bit 105, and circulate upwardly through the annulus region between the outside of the drill string 12 and the wall of the borehole 11, as indicated by the directional arrows 9. In this well known manner, the drilling fluid 26 lubricates the drill bit 105 and carries formation cuttings up to the surface, as the fluid 26 is returned to the pit 27 for recirculation.

The bottom hole assembly 100 of the wellsite system of FIG. 1 may include a logging-while-drilling (LWD) module 120 and/or a measuring-while-drilling (MWD) module 130, a roto-steerable system and motor 150, and the drill bit 105. The LWD module 120 can be housed in a special type of drill collar, as is known in the art, and can contain one or more known types of logging tools. It will also be understood that more than one LWD module can be employed, as generally represented at numeral 120A. As such, references to the LWD module 120 can alternatively mean a module at the position of 120A as well. The LWD module 120 may include capabilities for measuring, processing, and storing information, as well as for communicating with surface equipment. The LWD module 120 may be employed to obtain various downhole measurements.

The MWD module 130 can also be housed in a special type of drill collar, as is known in the art, and can contain one or more devices for measuring characteristics of the drill string and drill bit. It will also be understood that more than one MWD can be employed, as generally represented at numeral 130A. As such, references to the MWD module 130 can alternatively mean a module at the position of 130A as well. The MWD module 130 may also include an apparatus for generating electrical power to the downhole system. Such an electrical generator may include, for example, a mud turbine generator powered by the flow of the drilling fluid, but other power and/or battery systems may be employed additionally or alternatively. In the wellsite system of FIG. 1, the MWD module 130 may include one or more of the following types of measuring devices: a weight-on-bit measuring device, a torque measuring device, a vibration measuring device, a shock measuring device, a stick slip measuring device, a direction measuring device, and/or an inclination measuring device.

The BHA 100 may also be provided with a telemetry device 138 for mud pulse telemetry. The telemetry device 138 may be utilized to modulate pressure pulses in the drilling fluid 26 to transmit downhole measurements to the Earth's surface. Modulated changes in the pressure of the drilling fluid 26 may be detected at a surface system processor at the surface equipment, or in a processor of the BHA 100 (e.g., as part of the MWD module 130). The surface system processor may interpret the modulated changes in the pressure of the drilling fluid 26 to reconstruct the measurements collected and sent by telemetry device 138. The modulation and demodulation of a pressure wave are described in detail in commonly assigned U.S. Pat. No. 5,375,098. The reverse may also be implemented, though not shown in FIG. 1, wherein the telemetry device 138 is positioned in the mud line at the surface to modulate pressure pulses in the drilling fluid 26 to transmit downlink commands from the Earth's surface to the BHA 100, detected by a pressure transducer at the BHA 100.

The surface system processor may be implemented using any desired combination of hardware and software. For example, a personal computer platform, workstation platform, etc. may store on a computer readable medium, for example, a magnetic or optical hard disk, or random access memory and execute one or more software routines, programs, machine readable code, or instructions to perform the operations described herein. Additionally or alternatively, the surface system processor may utilize dedicated hardware or logic such as, for example, application specific integrated circuits, configured programmable logic controllers, discrete logic, analog circuitry, or passive electrical components to perform the functions or operations described herein.

Still further, the surface system processor may be positioned proximate or adjacent to the drilling rig 10. In other words, the surface system processor may be co-located with the drilling rig 10. Alternatively, a part of or the entire surface system processor may be located remote with respect to the drilling rig 10. For example, the surface system processor may be operationally and communicatively coupled to the telemetry device 138 via any combination of one or more wireless or hardwired communication links (not shown in the drawings, which be via a packet switched network (e.g., the Internet), hardwired telephone lines, cellular communication links, or other radio frequency based communication links which may utilize any communication protocol as known to one of ordinary skill in the art). The BHA 100 may also include one or more processors or processing units (not shown in the drawings).

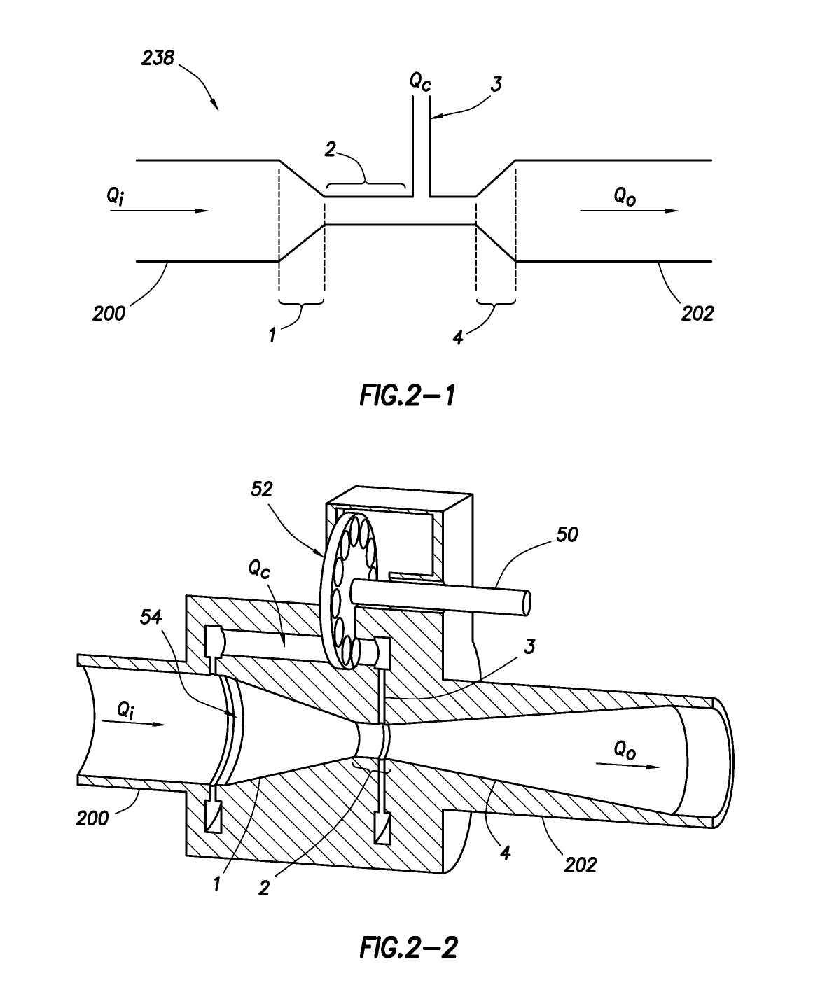

Turning now to FIGS. 2-1 and 2-2, various cross-sectional views are presented of a pulse generator 238 in accordance with various embodiments of the present disclosure, which can be employed as the telemetry device 138 of FIG. 1. As shown in FIG. 2-1, the pulse generator has an input port 200 and an output port 202. An input fluid flow Qᵢ enters the pulse generator 238 at the input port 200, and an output fluid flow Qₒ exits the pulse generator at the exit port 202. As can be seen, a constricting conduit 2 or throat couples between the input port 200 and the output port 202. A converging portion 1 narrows down from the dimension of the input port 200 to the dimension of the constricting conduit 2 and a diffusing portion 4 tapers out from the dimension of the constricting conduit 2 to the dimension of the output port 202. A control port 3 inputs a control flow Q_{c} into the constricting conduit just before the tapering out begins of the diffusing portion 4.

The pulse generator 238 operates as a fluidic amplifier, in that in passing through the pulse generator, a pressure drop is generated as the fluid flow exits the constricting conduit 2. The pressure drop can be modulated, and thus encoded for telemetry purposes, by selectively applying the control flow Q_{c} at the control port 3. The amplified pressure drop may be based on destabilizing the flow in the constricting conduit 2, just before entering the diffusing portion 4. The destabilization may be achieved by fluid injection. The distance between the control port 3 and the start of the diffusing portion 4 may be of a length short enough to ensure that the destabilized flow does not recover before entering the diffusing portion 4. Principles of Venturi style fluidic amplifiers used as flow meters are described, for example, in H. Wang, G. H. Priestman, S. B. M. Beck and R. F. Boucher, ‘Development of fluidic flowmeters for monitoring crude oil production’, Flow Meas. Instrum., Vol. 7, No. 2, pp. 91-98, 1996.

FIG. 2-2 shows the pressure pulse generator 238 in further detail. A controller 50 is coupled to a control throttle 52. The controller 50 may be, for example, a pump, a valve, and a fluidic device. The term “throttle” here is intended to include various mechanical throttles, pumps, valves, fluidic devices, chokes, actuators, or fluid regulators, and is not intended to be limiting. The control flow, Q_{c}, is, as shown in FIG. 2-2, bled from the main flow through control port 3 at a control flow bleed 54 located upstream of the converging portion 1 so that at any instant the flow entering converging portion is Qᵢ-Q_{c}. A separate fluid source may be provided (not shown) to supply an amount of fluid to selectively input, by the controller 50, as the control flow Q_{c}.

At the output port 202 departing the tapered portion, the output flow Qₒ is about the same as the fluid flow Qᵢ entering the pulse generator plus the control flow Q_{c}. In some embodiments, the control flow Q_{c} is a percentage of the input flow Qᵢ, such that an amount of power consumed in manipulating the flow is less for Q_{c} than the amount of power that would otherwise be consumed in manipulating the main flow. For example, a control flow Q_{c} of about 10% of the input flow Qᵢ may be used. However, any percentage of the input flow Qi could be selected as the amount for the control flow Q_{c}. In another example, a plurality of pressure pulses may be produced in a binary pattern by alternating 0% control flow and 100% of the control flow, in a continuous pattern by gradually ranging between 0% control flow and 100% of the control flow, or at a predetermined frequency.

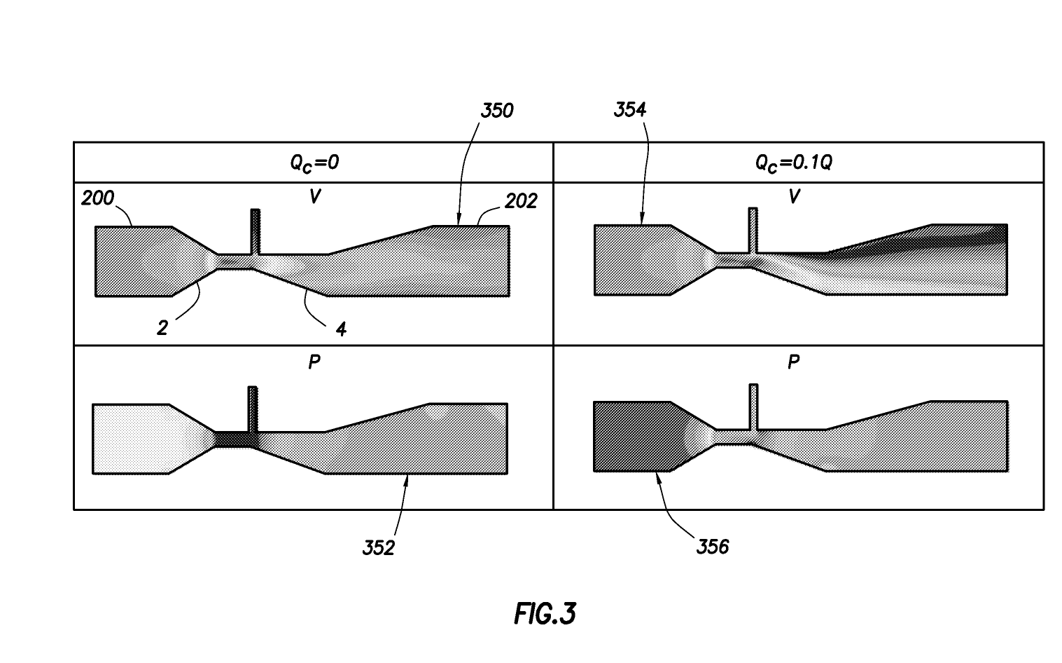

FIG. 3 shows a qualitative comparative chart of change graphically displayed for velocity and pressure fields through a device, such the pressure pulse generator 238 as illustrated in FIGS. 2-1 and 2-2. In the charts as shown, the velocity and pressure fields are shown for a control flow of about zero and a control flow of about 0.10 of the fluid flow through the pressure pulse generator. As shown in the velocity plot 350 for a control flow Q_{c}=0, in the area of the constricting conduit 2, the velocity increases as indicated by darker shading, and then decreases in the greater dimension of the diffusing portion 4 as indicated by lighter shading. As shown in the pressure plot 352 for a control flow Q_{c}=0, pressure reduces in the constricting conduit 2, and increases upon passing into the diffusing portion 4.

The pressure drop between the inlet 200 of the pressure pulse generator 238 and the outlet 202 may be low because of, for example, recuperation of pressure in the diffusing portion 4. As shown in the velocity plot 354, for a control flow Q_{c}=0.1Qᵢ the velocity decreases in the diffusing portion 4, but increases in the outlet 202 as indicated by the darker shading. As shown in the pressure plot 356 for the control fluid Q_{c}=0.1Qᵢ pressure increases in the inlet 356 and decreases upon entry into the constricting portion 2. As indicated by the pressure plot 356, there may be less recuperation of pressure compared with the pressure plot 352 when the flow enters the diffusing portion 4 and consequently there may be a greater magnitude of pressure drop between the inlet 200 and outlet 202 of the pressure pulse generator 238 than for control flow Q_{c}=0.

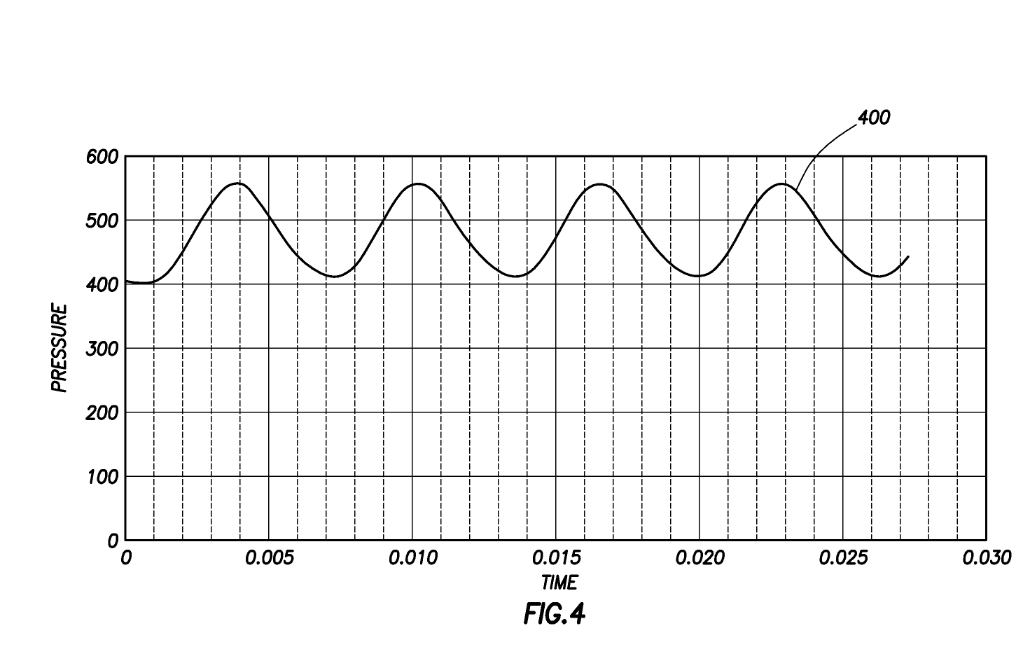

FIG. 4 depicts an example plot of a pressure signal 400 generated by a pressure pulse generator (e.g., 238 of FIGS. 2-1 through 3). The plot depicts pressure (y-axis) versus time (t) for a pressure pulse generator with a throat width of 5 mm and geometry depth to throat width ratio of 4. In this example, water flows through the pulse generator at 250 gallons per minute (GPM) (946.35 liters/min). A control flow rate is varied in sinusoidal fashion from 0 to 0.1Q at a frequency of 158 Hz, thereby providing a mean control flow rate of about 0.05Q. The control flow may be bled from a main flow at a location upstream of the pulse generator so that flow entering the converging portion 1 experiences a modulation between about 0.9 and about 1.0 times the upstream flow (see, e.g., FIG. 2-2). FIG. 4 shows the resulting pressure signature 400 (pressure vs. time) produced under the conditions described by this example for a device in accordance with an embodiment of the present disclosure.

FIGS. 5-1 and 5-2 depict another embodiment of a pressure pulse generator 538. Pressure pulse generator 538 may be similar to the pressure pulse generator 238 of FIGS. 2-1 and 2-2. In this version, the pressure pulse generator 238 has a converging portion 501 and a diverging portion 504 with diameters φᵢ and φₒ, respectively, of approximately 42.2 mm, a constricting conduit 503 has a diameter φ_{c} of approximately 13 mm, converging angle α_{c} of approximately 32.6°, and diffusing angle α_{d} of approximately 15°.

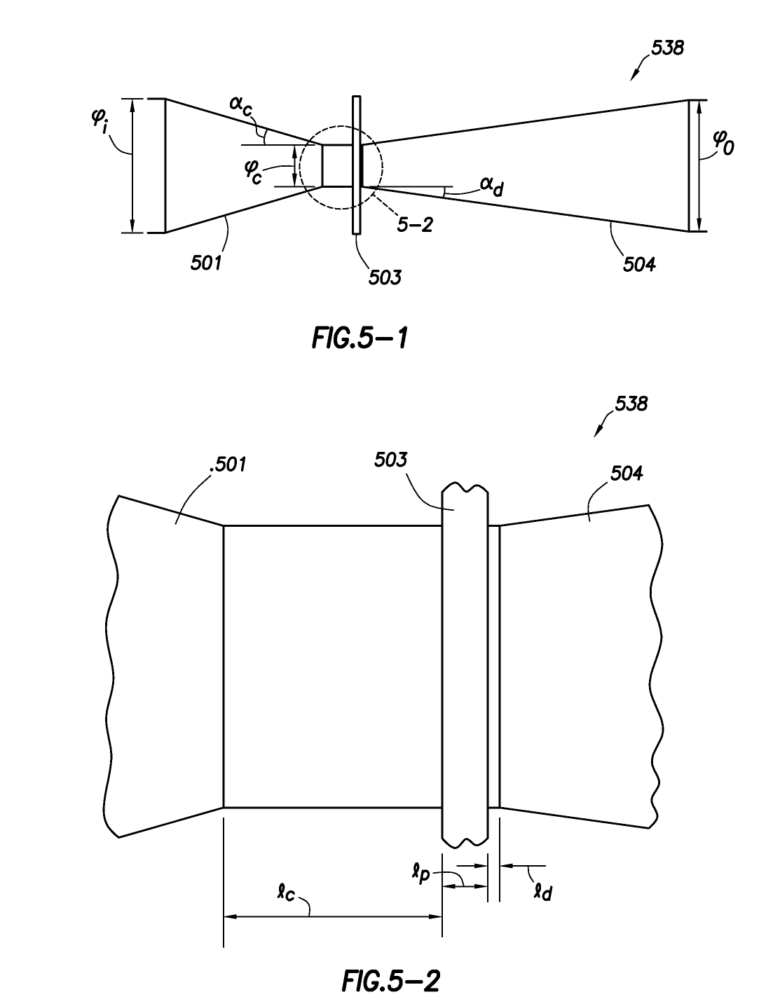

In the detail shown in FIG. 5-2, a distance l_{c} from the end of the converging portion 501 to an edge of the control port 503 may be about 12.7 mm, the width of the control port lₚ may be approximately 2.1 mm and the distance l_{d} from the edge of the control port 503 to the start of the diffusing portion 504 is a distance l_{d} of approximately 0.5 mm. As noted previously, the distance l_{d} from the control port 503 to the start of the diffusing portion 504 may be selected as a short enough distance that the destabilization caused by the entrance of the control flow is not recovered before the flow enters the diffusing portion 504.

In the example of FIGS. 5-1 and 5-2, a fluid density range in actual application may be from about 8 to about 18 ppg (pounds per gallon) (from about 958.61 to about 2156.88 grams per liter), with a flow rate range of about 200 to about 300 gpm (from about 757.08 to about 1135.6 liters per gallon) using, for example, water as the fluid. A corresponding telemetry rate may have a bit rate range of from about 1 to about 24 Hz. The configuration as depicted may be used with, for example, fluid having particles of about 8 mm or less in diameter to avoid erosion and jamming.

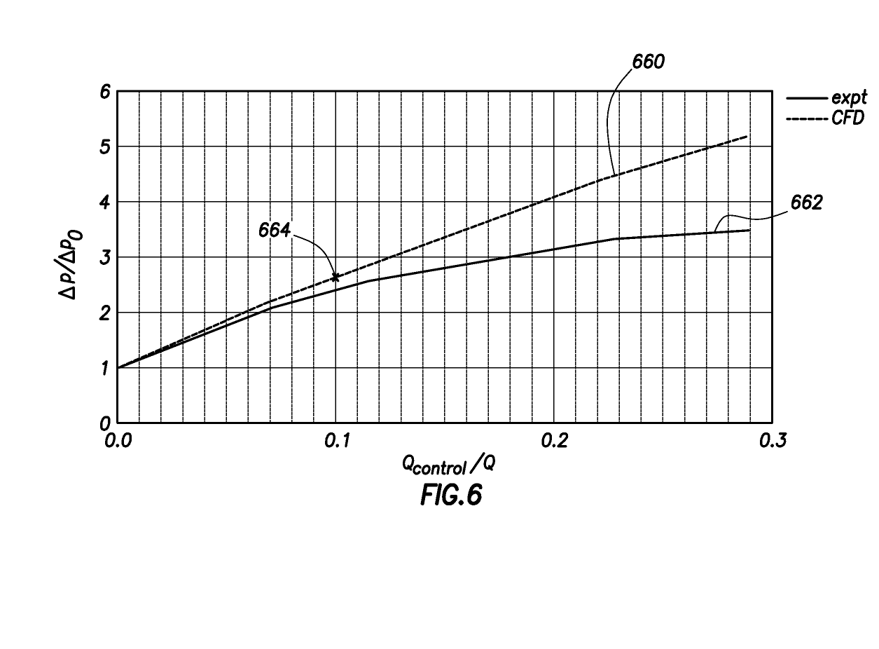

FIG. 6 is a graph depicting pressure amplification (Δp/Δp₀) as a function of control flow rate ratio (Q_{control}/Q) for the pressure pulse generator 538 of FIG. 5 and at a flow rate of about 2.65 m³/hr (11.65 gpm) water. The graph shows both experimental results 660 and predicted (or computational fluid dynamics, “CFD”) results 662. The pressure amplification is a ratio of pressure drop across the pressure pulse generator 538 from FIG. 5 at a finite control flow rate to a pressure drop across the pressure pulse generator 538 when the control flow rate is stopped. As can be seen, there is an amplification at a point 664 of 2.5 at an example control flow rate of 0.1 times the total flow rate. Note that the amplification increases as the flow rate (Reynolds number) of the fluid increases.

The CFD model predicts an amplification up to a control flow rate ratio of just below 0.1 times the total flow rate within a small error threshold. Above a control flow rate ratio of 0.1, there is a difference between predicted and measured amplifications, due, for example, to cavitation that may occur at relatively low line pressures. In various embodiments, actual amplification achieved may vary with the dimensions of the pulse generator and the density and viscosity of the drilling fluid passing through the pulse generator.

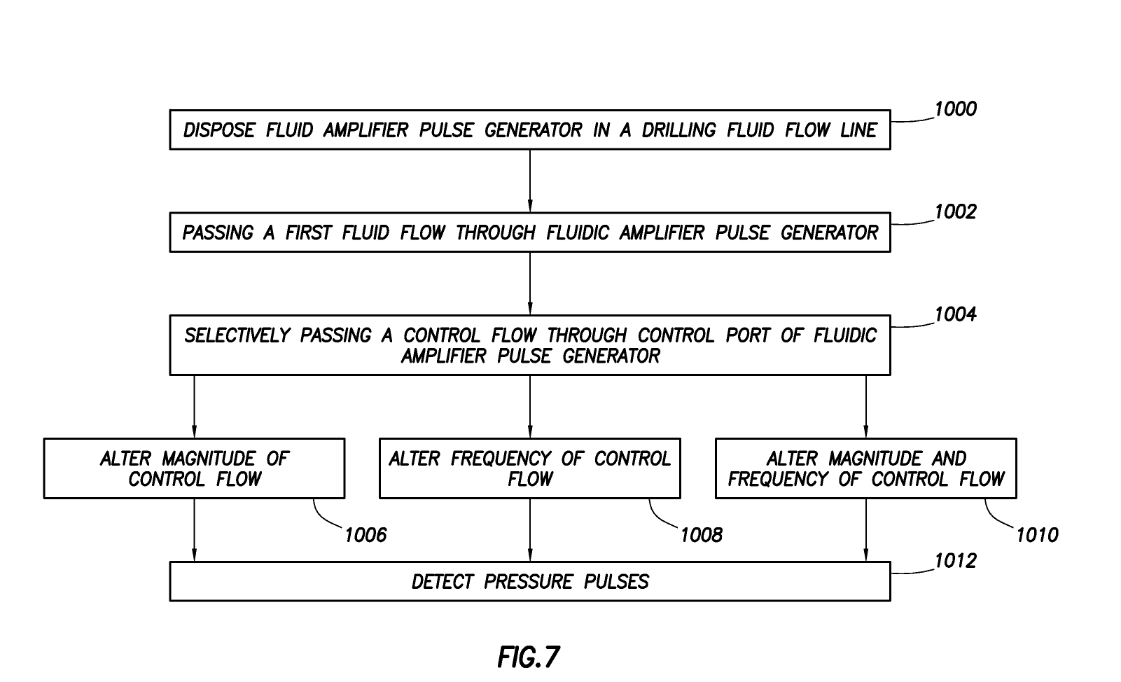

FIG. 7 is a flowchart for a method in accordance with one embodiment of the present disclosure. At 1000, the method includes disposing the pulse generator in a drilling fluid flow line (see, e.g., FIGS. 1-1 through 2-2). At 1002, the method includes passing a first fluid flow through the pulse generator. At 1004, the method includes selectively passing a control flow through a control port of the pulse generator in the constricting conduit 2, just before the start of the diffusing portion 4. The control flow may optionally be bled from the first fluid flow at a location upstream of the constricting conduit 2, or alternatively, may be provided by an additional, separate fluid source.

Depending on the type of modulation (i.e., amplitude modulation or frequency modulation) for the application at hand, various actions can take place. At 1006, the method can include altering the magnitude of the control flow, such that the change in the pressure drop is greater (or less), and amplitude modulation is achieved. At 1008, the method can include altering the frequency of the control flow, such that the frequency in the change in pressure drop is greater (or less), and frequency modulation. At 1010, the method can include altering both the magnitude and the frequency of the control flow, such that modulation of a combination of amplitude and frequency can be achieved. At 1012, the method includes detecting the generated pressure pulses resulting from the pressure and velocity changes inside the pulse generator.

Although a few example embodiments have been described in detail above, those skilled in the art will readily appreciate that many modifications are possible in the example embodiments without materially departing from this invention. Accordingly, such modifications are intended to be included within the scope of this disclosure as defined in the following claims. In the claims, means-plus-function clauses are intended to cover the structures described herein as performing the recited function and not simply structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A pressure pulse generator for generating pulses in a drilling fluid to communicate between a bottom hole assembly in a wellbore and surface equipment, comprising:
an input port having an input dimension into which the drilling fluid Qᵢ enters;
an output port having an output dimension out of which the drilling fluid Qₒ exits;
a constricting conduit that provides fluid communication between the input port and the output port;
a control port that inputs a control fluid Q_{c} into the constricting conduit; and
a control device that generates at least one pulse in the drilling fluid by selectively altering flow of the control fluid.

2. The pressure pulse generator according to claim 1, the constricting conduit further comprising a convergent portion that narrows an area of fluid communication between the input port and the constricting conduit.

3. The pressure pulse generator according to claim 1, the constricting conduit further comprising a diffusing portion that broadens an area of fluid communication between the constricting conduit and the output port.

4. The pressure pulse generator according to claim 1, wherein the control fluid Qc comprises a percentage of the drilling fluid ranging from zero percent to ten percent.

5. The pressure pulse generator according to claim 1, wherein the controller further comprises one of a pump, a valve, and a fluidic device.

6. The pressure pulse generator according to claim 1, wherein the controller generates a plurality of pressure pulses for one of amplitude modulation and frequency modulation.

7. The pressure pulse generator according to claim 1, wherein the controller generates a plurality of pressure pulses in a binary pattern or a continuous patter.

8. The pressure pulse generator according to claim 1, wherein the control device generates a plurality of pressure pulses at a predetermined frequency.

9. The pressure pulse generator according to claim 1, further comprising a bypass pathway coupled to the input port upstream of the constricting conduit whereby an amount of fluid is diverted as the control fluid Qc.

10. The pressure pulse generator according to claim 1, further comprising an additional fluid source supplying an amount of additional fluid to input as the control fluid.

11. The pressure pulse generator according to claim 1, further comprising a throttle.

12. A method for generating pressure pulses in a drilling fluid between a bottom hole assembly in a wellbore and surface equipment, comprising:
disposing in a fluid flow line a pressure pulse generator comprising:
an input port having an input dimension into which the drilling fluid enters;
an output port having an output dimension out of which the drilling fluid exits;
a constricting conduit that provides fluid communication between the input port and the output port;
a control port that inputs a control fluid into the constricting conduit; and
a control device that generates at least one pulse by selectively altering the control fluid;
passing the drilling fluid through the input port of the pulse generator to the output port of the pulse generator; and
generating the at least one pulse by selectively passing the control fluid through the control port to the constricting conduit of the pressure pulse generator.

13. The method according to claim 12, further comprising modulating an amplitude of the at least one pulse by altering an amount of the control fluid Q_{c}.

14. The method according to claims 12, further comprising modulating a frequency of the at least one pulse by altering a frequency at which the control fluid Qc is increased or decreased.

15. The method according to claims 12, wherein the control fluid Qc comprises a percentage of the drilling fluid ranging from zero percent to ten percent.
